(19) United States
(12) Patent Application Publication
(10) Pub. No.: US 2008/0017721 A1
(43) Pub. Date: Jan. 24, 2008

(54) Mobile Payment Device with Magnetic Stripe

(75) Inventor: Rich Zehnacker, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/782,526

(22) Filed: Jul. 24, 2007

Related U.S. Application Data
(60) Provisional application No. 60/833,022, filed on Jul. 24, 2006.

(51) Int. Cl. G06K 19/06; G06K 5/00

(52) U.S. Cl. 235/493; 235/380

(57) ABSTRACT

According to the invention, a mobile payment device is disclosed. The mobile payment device may include a body, an input device, and a substrate having a magnetic stripe. The input device may be configured to receive data from a plurality of data sources. The magnetic stripe may be configured to store data received from at least one of the plurality of data sources. The substrate may be movable coupled with the body, and may be configured to move between a first and a second position. The magnetic stripe may at least partially protrude from the body in the first position, and not protrude from the body in the second position.

### CROSS-REFERENCE TO RELATED APPLICATIONS

This application claims priority to Provisional U.S. Patent Application No. 60/833,022 filed Jul. 24, 2006, entitled “MOBILE PAYMENT DEVICE WITH MAGNETIC STRIPE,” the entire disclosure of which is hereby incorporated by reference, for all purposes, as if fully set forth herein.

### BACKGROUND OF THE INVENTION

This invention relates generally to personal electronic devices. More specifically the invention relates to mobile payment devices.

Today merchants and service providers accept many forms of payment. Many merchants will accept cash, credit cards, debit cards, stored-value cards, checks, and promotional items such as coupons. All of theses forms of payment must often be carried by a consumer because some merchants and/or service providers may only accept some of the various possible forms of payment. Sometimes a customer may not pre-plan a visit to a specific merchant and/or service provider, so the consumer may wish to carry the different forms of payment in case the consumer does happen to make an unplanned visit.

This can lead to a great deal of methods of payments being carried by a consumer on a day-to-day basis. Additionally, a consumer may also need to carry other items regularly such as drivers license, identification cards, loyalty program cards, and membership cards. When a consumer has to carry all of these items, they may also become disorganized and misplaced, causing security concerns, and possibly causing transactions to consume more time. Embodiments of the present invention provide solutions to these and other concerns.

### BRIEF DESCRIPTION OF THE INVENTION

In one embodiment, an apparatus for storing and outputting data from a plurality of data sources is provided. The apparatus may include a processor, an input device, a data storage, a display device, a non-visual output device, and a magnetic stripe. The input device may be in communication with the processor, and may also be configured to receive data from a plurality of data sources. The data storage device may be in communication with the processor, and may also be configured to store data received from the plurality of data sources. The display device may be in communication with the processor, and may also be configured to display data received from at least one of the plurality of data sources. The non-visual output device may be in communication with the processor, and may also be configured to output data received from at least one of the plurality of data sources. The magnetic stripe may be configured to store data received from at least one of the plurality of data sources.

In some embodiments, the display device may be further configured to display a graphical interface, and the input device may be further configured to allow a user to interact with the graphical interface.

In some embodiments, the magnetic stripe may be characterized by magnetic properties and the apparatus may further include a magnetic stripe encoder configured to change the magnetic properties of the magnetic stripe, and consequently which data received from a data source is stored on the magnetic stripe. In other embodiments, the apparatus may include a magnetic properties control device configured to control the magnetic properties of the magnetic stripe. For example, the magnetic properties control device may actively change the properties without having to process the magnetic stripe through an encoder.

In some embodiments, the non-visual output device may be configured to output data received from a specific data source based at least in part on the instruction received from the user of the input device. In these and other embodiments the magnetic stripe may be configured to store data received from a specific data source based at least in part on the instruction received from the user of the input device.

In some embodiments, the processor may be configured to monitor a credit limit and/or balance associated with at least one data source and/or be configured to monitor a consumer loyalty program associated with at least one data source.

In some embodiments, the input device may further be configured to receive the security code from the user. The processor, the input device, data storage device, display device, non-visual output device, or the magnetic stripe may be configured to be enabled or disabled based at least in part on the security code received from the user. In some embodiments, the non-visual output device may be further configured to transmit an unauthorized use message based at least in part on the security code received from the user.

In yet other embodiments, the apparatus may further comprise a biometric input device. The biometric input device may be configured to receive biometric data from a user. The processor, input device, data storage device, display device, non-visual output device, or the magnetic stripe may be configured to be enabled or disabled based at least in part on the biometric data received from the user. The non-visual output device may also be further configured to transmit an unauthorized use message based at least in part from the biometric data received from the user.

In some embodiments, the apparatus may also include a body, and the magnetic stripe may be further configured to be retractable into the body. In other embodiments, the apparatus may include a body and a clip, wherein the clip is configured to compress objects between the body and the clip. In some embodiments, the apparatus may further include a cover for the body, wherein the cover for the body is configured to protect at least one of the processor input device, the data storage device, the display device, the non-visual output device, the magnetic stripe, and the body.

In some embodiments, the apparatus may also include a radio frequency identification (“RFID”) indicator device configured to indicate to a user that a radio frequency identification transceiver, possibly on a point-of-sale device, is, or is not, available for communication with the non-visual output device. The radio frequency identification indicator device may include a red light, a green light, and a vibration device. The red light may be configured to illuminate when a radio frequency identification transceiver is not available for communication. The green light may be configured to illuminate when a radio frequency identification transceiver is available for communication. The vibration device may be configured to vibrate for a certain time when a radio frequency identification transceiver first becomes available. In other embodiments, the apparatus may further include an independent vibration device configured to vibrate for a certain time when at least one of the processor, the input device, the data storage device, the display device, and the non-visual output device are active. Some embodiments may use one vibration device to provide the functionality of this vibration device as well as the vibration device in a radio frequency identification indicator device.

In some embodiments, the processor, the data storage device, and/or other component may comprise instructions executable by the processor or other component for decoding audio files, for providing a web browser in communication with the internet, for processing a received global positioning system transmission, and/or for processing a mobile phone transmission.

In some embodiments the processor, the data storage device, and/or other component may include instructions executable by the processor or other component for determining if a computer in communication with the input device has communicated with a merchant, a service provider, or a financial institution website. The processor, the data storage device, and/or other component may further include instructions executable by the processor or other component for taking at least one specific action in response to the determination that the computer in communication with the input device has communicated with a merchant, a service provider or a financial institution website. One possible specific action may include selecting data received from a certain data source and stored in the data storage device, based at least in part on which merchant, service provider, or financial institution website the computer has communicated with. The one specific action may further include outputting through the non-visual output device the selected data for reception by the computer.

In some embodiments, the processor, the data storage device, and/or other component may include instructions executable by the processor or other component for determining that a user using the device has selected data stored on the data storage device and received from a certain data source associated with a merchant, a service provider, or a financial institution. The instructions executable by the processor or other component may also include outputting through the non-visual output device instructions to a computer for taking at least one specific action in response to the determination that the user using the input device has selected data received from a certain data source associated with a merchant, a service provider or a financial institution. The one specific action may include communicating with the merchant's, service providers or financial institution's website and/or receiving from the non-visual output device the selected data.

In some embodiments, the display device may be configured to display a promotion in response to the input device establishing communication with a merchant, a service provider, or a financial institution. The promotion may include, merely by way of example, a coupon, sale information, and/or financing information. In some embodiments, the display device may be configured to display representation of at least one desired good or service associated with a merchant, service provider, or financial institution in response to the input device establishing communication with a device associated with the merchant, service provider or financial institution. This representation may, merely by way of example, include a grocery list.

In some embodiments, the apparatus may further include a power source. The power source may, merely by way of example, be a disposable battery, a rechargeable battery, capacitance device, and/or a solar cell. In some embodiments, the power source may also include a kinetic energy conversion device, where the kinetic energy conversion device is configured to convert motion of the kinetic energy device into electrical power.

In another embodiment, a method for storing and outputting data from a plurality of data sources is provided. The method may include steps performed by any of the apparatuses described by the claims or written description of this application.

In another embodiment, a method for storing and outputting data from a plurality of data sources is provided. The method may include steps for using any of the apparatuses described by the claims or written description of this application. The method may further include adding value to a stored value instrument for which associated data is stored in the data storage device. In some embodiments, the method may include calculating a fee to apply to a financial transaction involving the use of the apparatuses described by the claims or written description of this application. The fee may be assessed to a merchant, service provider, financial institution or user of the apparatus as described by the claims or written description of this application.

### BRIEF DESCRIPTION OF THE DRAWINGS

The present invention is described in conjunction with the appended figures:

FIG. 1 is a block diagram of an embodiment of the invention storing and outputting data from a plurality of data sources, including a processor, an input device, a data storage device, a display device, a non-visual output device, and a magnetic stripe;

FIG. 2 is a block diagram of an embodiment of the invention, similar to that shown in FIG. 1, except showing various possible input devices;

FIG. 3 is a block diagram of an embodiment of the invention similar to that shown in FIG. 2, except showing various possible data storage devices;

FIG. 4 is a block diagram of an embodiment of the embodiment of the invention similar to that in FIG. 3, except showing the display device as an LCD display;

FIG. 5 is a block diagram of an embodiment of the invention similar to that as shown in FIG. 4, except showing various possible non-visual output devices;

FIG. 6 is a block diagram of an embodiment of the invention similar to that shown in FIG. 5, except showing various types of magnetic stripes;

FIG. 7 is a block diagram of an embodiment of the invention similar to that shown in FIG. 6, except also including a magnetic stripe encoder;

FIG. 8 is a block diagram of an embodiment of the invention similar to that shown in FIG. 6, except also including a magnetic properties control device;

FIG. 9 is a block diagram of an embodiment of the invention similar to that shown in FIG. 8, except also including a biometric input device;

FIG. 10 is a block diagram of an embodiment of the invention similar to that shown in FIG. 1, except also including a body and showing the magnetic stripe as retractable;

FIG. 11 is a block diagram of an embodiment of the invention similar to that shown in FIG. 10, except also including a clip;

FIG. 12 is a block diagram of an embodiment of the invention similar to that shown in FIG. 9, except also including a Radio Frequency Identification (“RFID”) indicator device;

FIG. 13 is a block diagram of an embodiment of the invention similar to that shown in FIG. 12, except showing the RFID indicator device including a red light, a green light and a vibration device;

FIG. 14 is a block diagram of an embodiment of the invention similar to that shown in FIG. 13, except also including a vibration device;

FIG. 15 is a block diagram of an embodiment of the invention similar to that shown in FIG. 14, except also showing various instructions executable by the processor stored on the data storage device;

FIG. 16 is a block diagram of an embodiment of the invention similar to that shown in FIG. 15, except also including a power source;

FIG. 17 is a block diagram of an embodiment of the invention similar to that shown in FIG. 16, except showing different types of possible power sources;

FIG. 18 is a block diagram of an embodiment of the invention similar to that shown in FIG. 16, except showing a kinetic energy conversion device as the power source;

FIG. 18A is a block diagram of an embodiment of the invention similar to that shown in FIG. 18, except showing a computer in communication with the input device and non-visual output device;

FIG. 19 is an isometric drawing of one apparatus of the invention for storing and outputting data from a plurality of data sources;

FIG. 20 is isometric drawing of an embodiment of the invention similar to that shown in FIG. 19, except showing the magnetic stripe in the retracted position;

FIG. 21 is a side view of an embodiment of the invention similar to that shown in FIG. 19, except showing a clip;

FIG. 22 is an isometric drawing of an embodiment of a the invention similar to that shown in FIG. 19, except also including a cover;

FIG. 23 is a block diagram of one method of the invention for storing and outputting data from a plurality of data sources; and

FIG. 24 is a block diagram of an exemplary computer system capable of being used in at least some portion of the apparatuses or systems of the present invention, or implementing at least some portion of the methods of the present invention.

In the appended figures, similar components and/or features may have the same numerical reference label. Furthermore, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix. In a few instances, a reference label may be followed by two letters. The second letter distinguishes individual components and/or features of a particular component having one letter following the reference label.

### DETAILED DESCRIPTION OF THE INVENTION

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

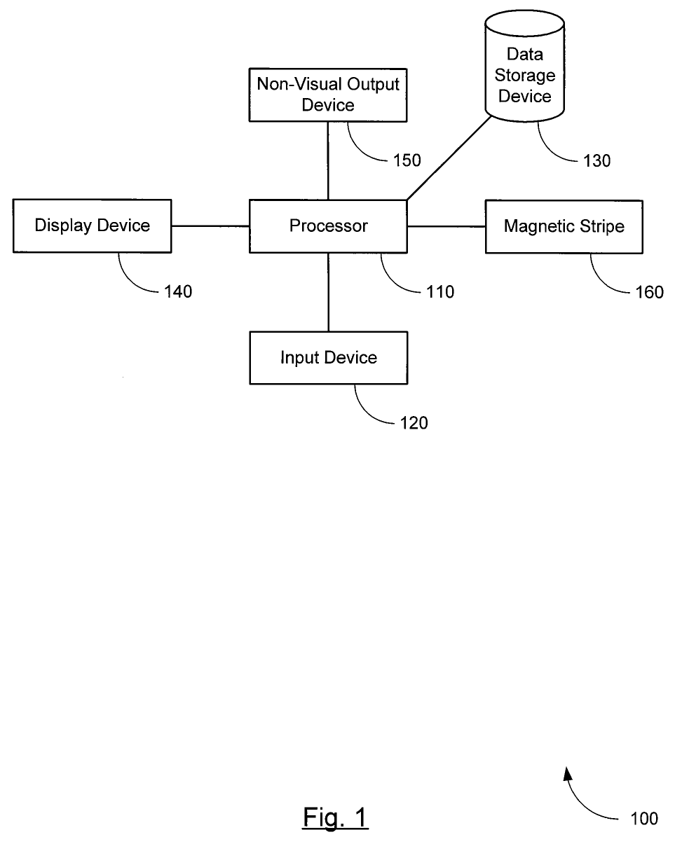

Turning now to FIG. 1, a block diagram of one apparatus 100 of the invention for storing and outputting data from a plurality of data sources is shown. Apparatus 100 may include a processor 110, an input device 120, a data storage device 130, a display device 140, a non-visual output device 150, and a magnetic stripe 160. Each of the various components may be in direct or indirect communication with processor 110, and/or other components of apparatus 100. Input device 120 may be configured to receive data from a plurality of data sources. Data storage device 130 may be configured to store data from the plurality of data sources. Display device 140 may be configured to display data received from at least one of the plurality of data sources. Non-visual output device 150 may be configured to output data received from at least one of the plurality of data sources. Magnetic stripe 160 may be configured to store data received from at least one of the plurality of data sources.

The plurality of data sources may include, merely by way of example, the following data sources: a credit card; a debit card; an automatic teller machine card; a retail store credit card; a stored-value instrument; a discount card a drivers license; an identification card; a student identification card; a library card; a membership card; a passport; a consumer loyalty program card; a health insurance card; an eye care insurance card; a dental care insurance card; a business card; a professional registration card; a rental authorization card; a security card or radio frequency identification security bob; and a remote source available via the Internet. The data sources may be in various forms, for example, electronic, audible, radio frequency, written, printed, or bar code. Additionally, a user may previously have memorized information from a possible data source, and that memorized information may be a data source.

A user may use apparatus 100 to store and output data from a plurality of data sources. The user may use input device 120 to input data sources. The data may be stored on data storage device 130. Display device 140 may possibly confirm to the user that the data has been received and/or stored. The user may then be at a merchant, service provider, or financial institution and desire to recall and output the stored data. The user, possibly using input device 120, may direct the apparatus 100 to output specific data from a specific data source at non-visual output device 150 and/or store the data on magnetic stripe 160. In some embodiments, a point-of-sale or other device at the merchant, service provider, or financial institution may communicate with input device 120 and direct non-visual output device 150 to output certain stored data. Processor 110 may direct and/or control the operations of any of the components of the apparatus 100.

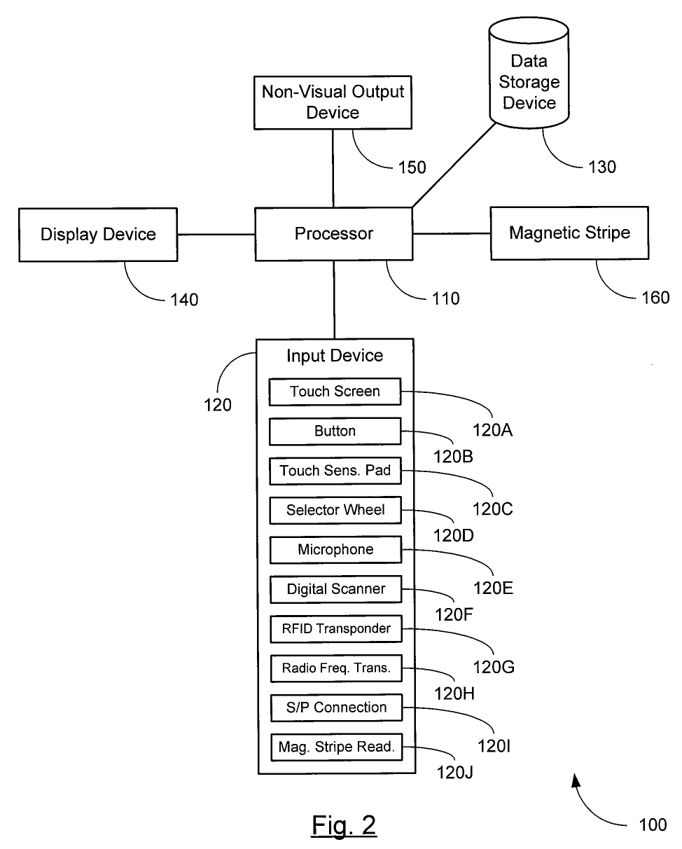

FIG. 2 is a block diagram of an embodiment of the invention, similar to that shown in FIG. 1, except showing various possible input devices 120. Input device 120, in some embodiments, may be one or more of the following: a touch screen 120A, at least one button 120B, at least one touch sensitive pad 120C, a selector wheel 120D, a microphone 120E, a digital scanner 120F, a radio frequency identification transponder 120G, a radio frequency transceiver 120H, a serial or parallel connection 120I, and/or a magnetic stripe reader 120J.

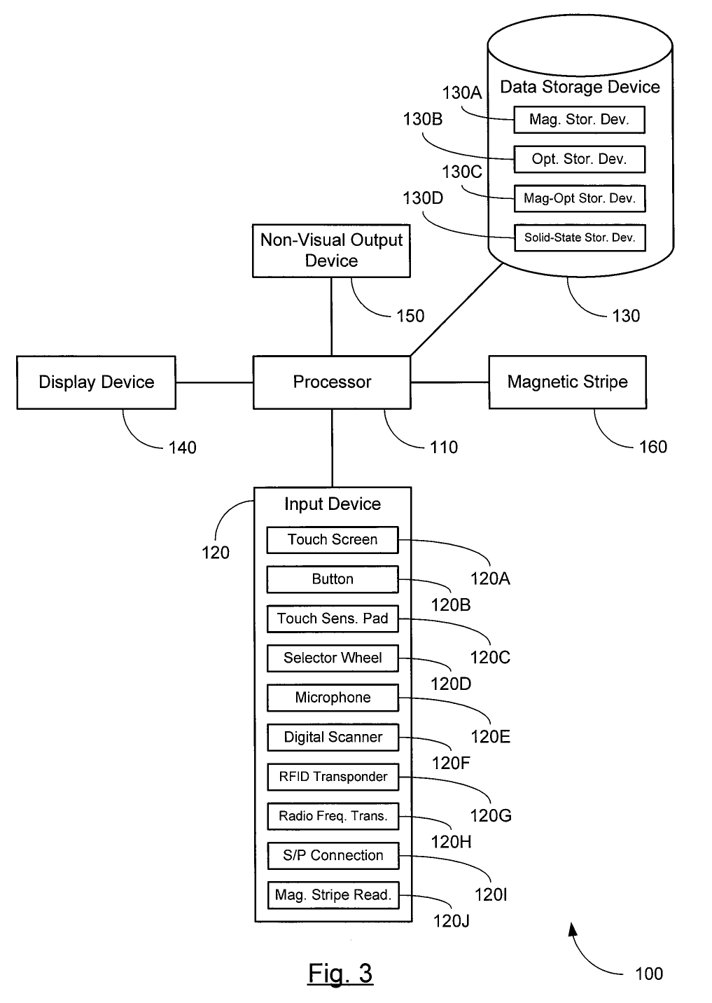

FIG. 3 is a block diagram of an embodiment of the invention similar to that shown in FIG. 2, except showing various possible data storage devices 130. Data storage device 130, in some embodiments, may be one or more of the following: a magnetic storage device 130A, an optical storage device 130B, a magneto-optical storage device 130C, and/or a solid-state storage device 130D.

In some embodiments, data storage device 130 may be a removable type of read-only memory or random-access memory media, including, but not limited to, magnetic storage devices, optical storage devices, magneto-optical storage devices, and/or solid-state storage devices. Removable media may be provided any number of physical forms including a proprietary casing, or industry standard flash memory formats such as CompactFlash, SmartMedia, Memory Stick, Multimedia Card, and/or Secure Digital Card. In some embodiments, read-only memory media may contain machine-executable instructions to provide additional functions not otherwise present in some embodiments of the apparatus. For example, global positioning system maps, entertainment software, and productivity software such as word processing and spreadsheet programs are but a few of the possible types of software that may be available on a removable type of memory used by apparatuses of the invention. Other functions that could be stored on data storage device will be discussed in greater detail below.

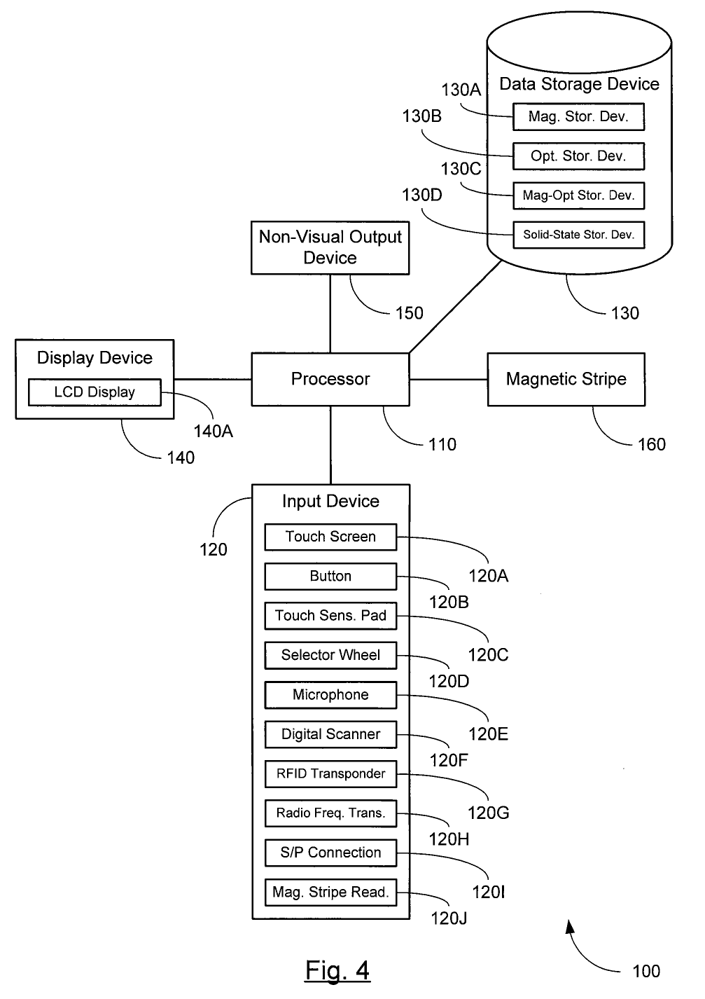

FIG. 4 is a block diagram of an embodiment of the invention similar to that shown in FIG. 3, except showing display device 140 as an LCD display 140A. Other types of display devices 140 may also be used in other embodiments. Digital light processing screens, plasma displays, light-emitting diode screens, organic light-emitting diode screens, surface-conduction electron-emitter displays, field emission displays, and/or liquid crystal on silicon displays are examples of other possible display devices 140 that may be used in apparatus 100. Display device 140 may be configured in some embodiments to display a graphical interface, and input device 120 may be configured to allow a user to interact with the graphical interface. In some embodiments, the graphical interface may be configured to display icons. The icons may be presented to a user in a hierarchical manner. For example, in some embodiments, data sources stored on data storage device 130 may be grouped into categories such as credit cards, debit cards, identity cards, membership cards, and miscellaneous. Each of these categories may be represented in a first menu by an icon. If one of the icons is selected, then a new set of icons may appear on display device 140, each possibly representing a different data source within the category.

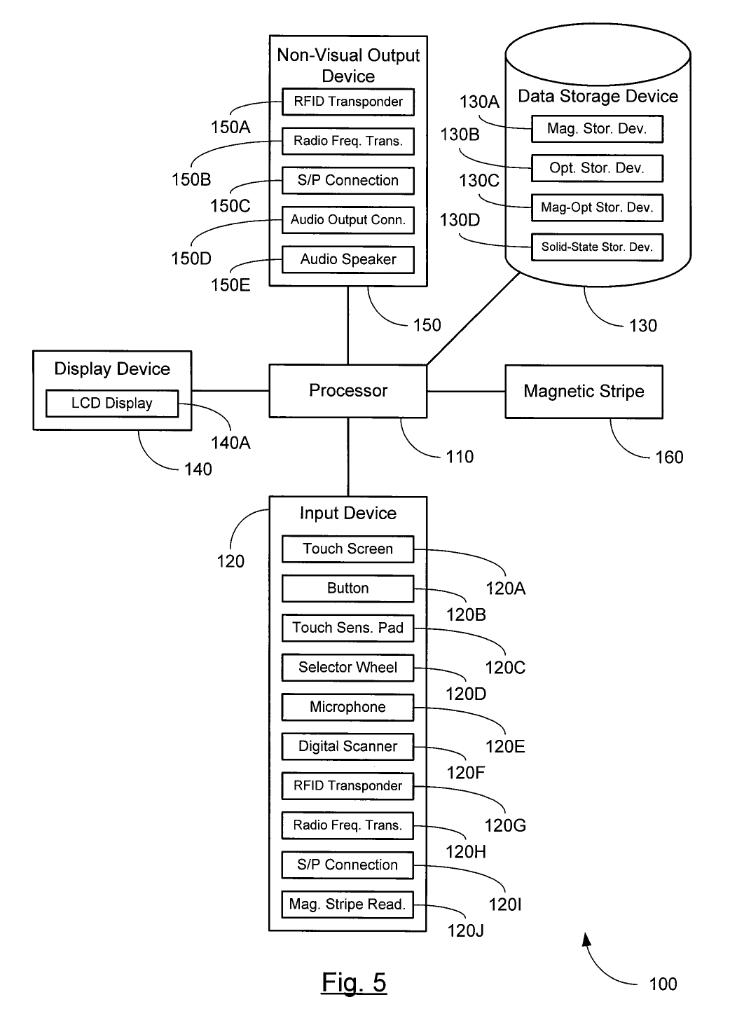

FIG. 5 is a block diagram of an embodiment of the invention similar to that as shown in FIG. 4, except showing various possible non-visual output devices 150. Non-visual output device 150, in some embodiments, may be one or more of the following: a RFID Transponder 150A, a radio frequency transceiver 150B, a serial or parallel connection 150C, an audio output connection 150D, and/or an audio speaker 150E. In some embodiments, non-visual out device 150 may be integral, or the same as, input device 120. For example, in some embodiments, apparatus 100 may have an RFID Transponder 150A or a radio frequency transceiver 150B which functions as both non-visual output device 150 and input device 120. Other devices such as serial or parallel connection 150 may also, in some embodiments, be configured to be both non-visual out device 150 and input device 120. Serial or parallel connection 120I,150C may be a Universal Serial Bus (“USB”) or FireWire (IEEE 1394) connection in some embodiments. Additionally, it should be noted that radio frequency transceiver 120H, 150B may be configured to receive and/or transmit any type of radio frequency signal, including, but not limited to, wireless networking or connection signals (for example, WiFi (IEEE 802.11) or Bluetooth (IEEE 802.15.1)), mobile phone communications, global positioning signals, and satellite music radio signals.

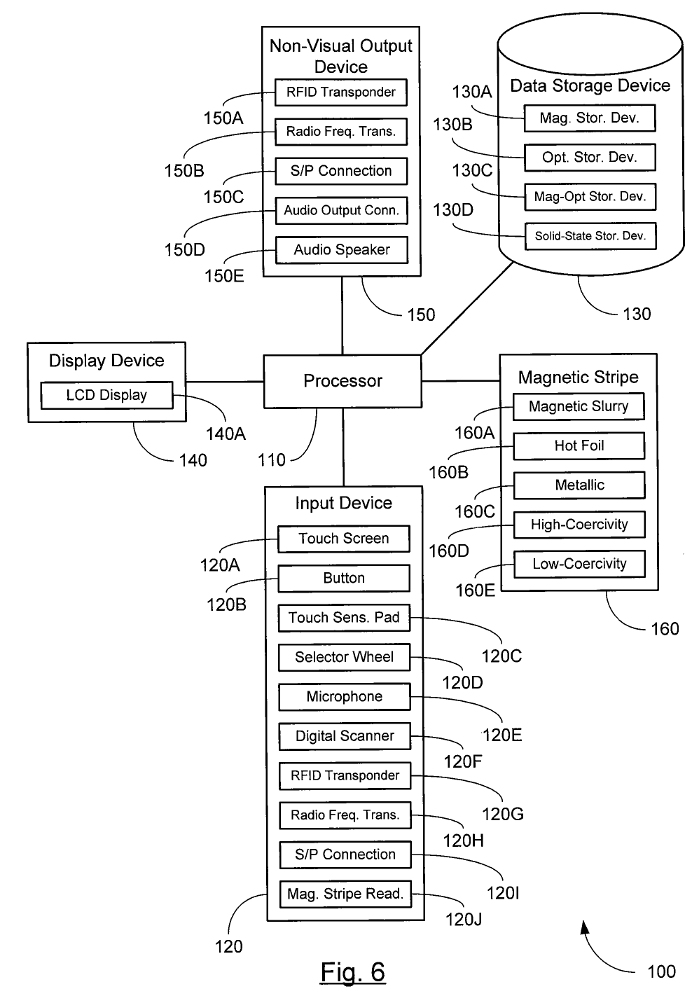

FIG. 6 is a block diagram of an embodiment of the invention similar to that shown in FIG. 5, except showing various types of magnetic stripes 160. Different types of magnetic stripes 160 may be used in various embodiments of the invention. Merely by way of example, magnetic stripe 160 may be a magnetic slurry type stripe 160A, a hot foil type stripe 160B, a metallic stripe 160C, a high-coercivity stripe 160D, and/or a low-coercivity stripe 160E. In some embodiments magnetic stripe 160 may be characterized by magnetic properties. The magnetic properties may differ over the surface are of the magnetic stripe, thereby representing data. Such data may, for example, represent the same or similar data stored on magnetic credit cards, drivers licenses, and other cards with magnetic stripes. The represented data may also represent data stored or located in or on other mediums such as text on a card, a radio frequency identifier, or electronically retrievable data from a source on the Internet.

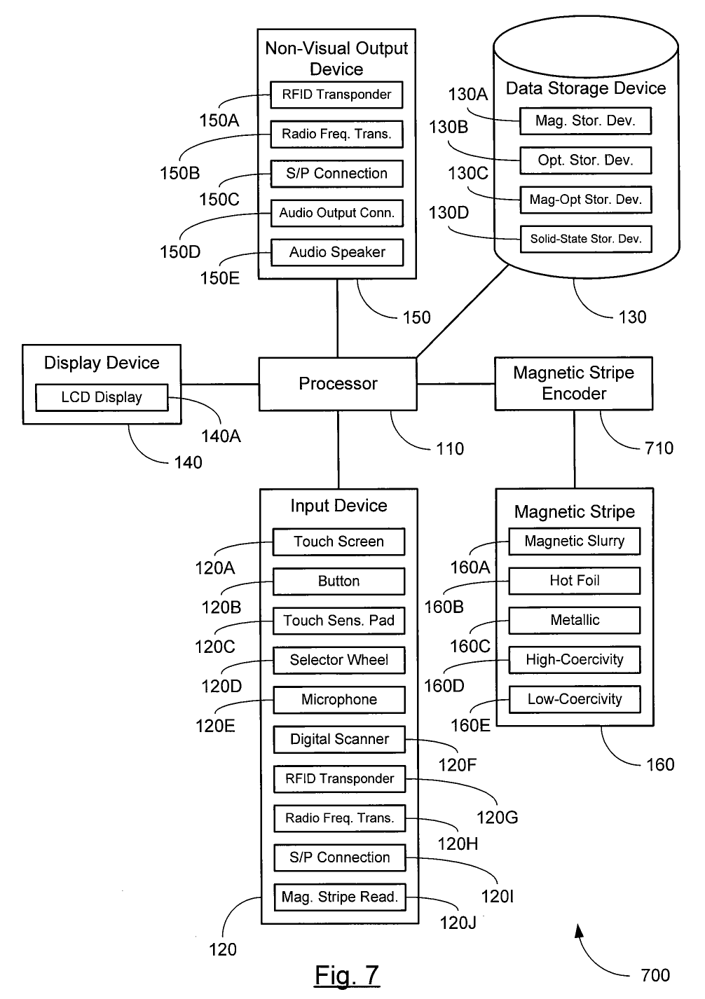

FIG. 7 is a block diagram of an embodiment 700 of the invention similar to that shown in FIG. 6, except also including a magnetic stripe encoder 710. Magnetic stripe encoder 710 may be in communication with processor 110. Magnetic stripe encoder 710 may be of various configurations. In some embodiments, magnetic stripe encoder 710 may be configured to move relative to magnetic stripe 160 and change the magnetic properties of magnetic stripe 160. In other embodiments, magnetic stripe 160 may be configured to move relative to magnetic stripe encoder 710 and change the magnetic properties of magnetic stripe 160. In yet other embodiments, both magnetic stripe encoder 710 and magnetic stripe 160 may remain stationary while the magnetic properties of magnetic stripe 160 are changed. By changing the magnetic properties of magnetic stripe 160, the data stored on magnetic stripe 160 may be changed.

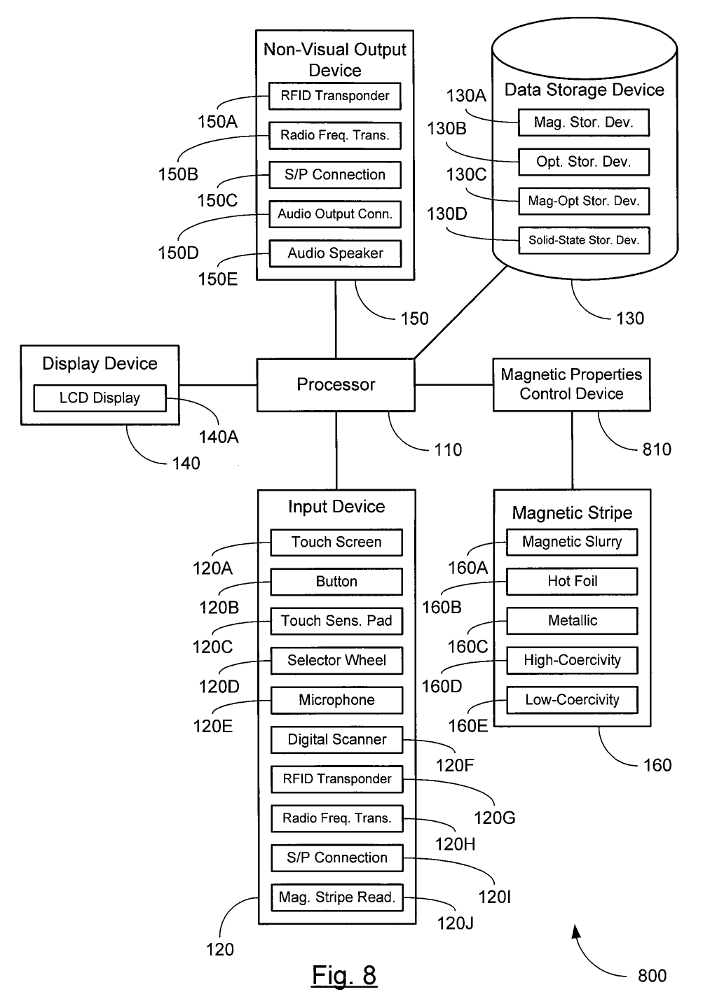

FIG. 8 is a block diagram of an embodiment 800 of the invention similar to that shown in FIG. 6, except also including a magnetic properties control device 810. Magnetic properties control device 810 may be configured to control the magnetic properties of magnetic stripe 160. Methods and apparatuses for controlling magnetic properties of a magnetic stripe are discussed in greater detail in U.S. Pat. No. 5,412,192, entitled “RADIO FREQUENCY ACTIVATED CHARGE CARD,” issued on May 2, 1995 to Robert J. Hoss, which is herein incorporated by reference in its entirety for all purposes. Magnetic properties control devices 810 may be configured to be able to actively control the magnetic properties of magnetic stripe 160, without the need for a magnetic stripe encoder 710 to change the magnetic properties from one passive state to another. In these embodiments, magnetic stripe 160 may, for example, be metallic or include solid state circuitry, which may be controlled by magnetic properties control device 810. By changing the magnetic properties of magnetic stripe 160, the data stored on magnetic stripe 160 may be changed.

In embodiments where magnetic stripe 160 is metallic or includes solid state circuitry, magnetic stripe 160 may be made to physically appear as a traditional magnetic stripe 160, for ease of use and integration by consumers, merchants, service providers, and financial institutions. Methods and apparatuses for controlling a solid state device to emulate a magnetic stripe are discussed in greater detail in U.S. Pat. No. 6,705,520, entitled “POINT OF SALE ADAPTER FOR ELECTRONIC TRANSACTION DEVICE,” issued on Mar. 16, 2004, and U.S. Pat. No. 6,769,607 entitled “POINT OF SALE DISPLAY ADAPTER FOR ELECTRONIC TRANSACTION DEVICE” issued on Aug. 3, 2004, both to Satyan G. Pitroda and Merul Patel, both of which are herein incorporated by reference in their entirety for all purposes.

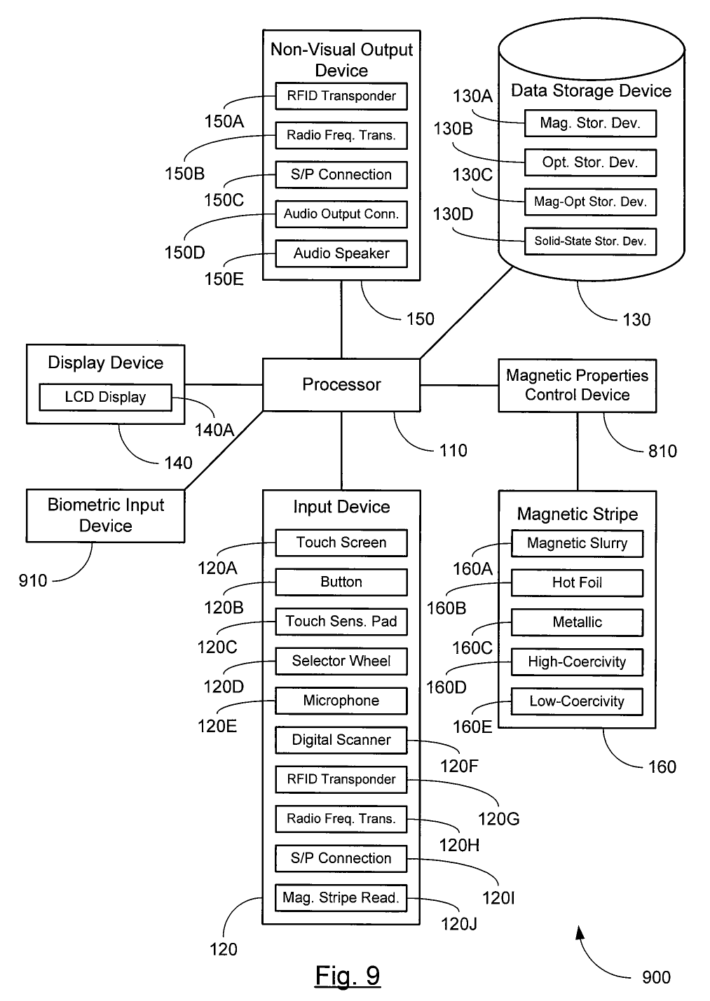

FIG. 9 is a block diagram of an embodiment 900 of the invention similar to that shown in FIG. 8, except also including a biometric input device 910. Biometric input device 910 may be configured to receive biometric data from a user as a security measure to enable or disable at least a portion of the apparatus 900. Based at least in part on the biometric data received from the user, processor 110, input device 120, data storage device 130, display device 140, non-visual output device 150, magnetic stripe 160, magnetic stripe encoder 710, magnetic properties control device 810 and/or any other component of the possible embodiments of the invention may be enabled or disabled. In embodiments where magnetic stripe 160 is retractable, an incorrect biometric entry may cause magnetic stripe 160 to retract, or stay retracted.

In some embodiments, a user, when initially commencing usage of the apparatuses of the invention may input biometric information, possibly a fingerprint, eye retina or iris patterns, facial patterns, and/or finger measurements. This biometric information may be stored, possibly in data storage device 130, and thereafter used to verify who the user is before allowing the apparatuses of the invention to operate. In some embodiments, multiple users may be allowed to use the apparatuses, and multiple sets of biometric information may be stored, for instance in the case of a husband and wife with joint financial accounts. In such embodiments, certain users may be restricted to recalling only certain portions of the data stored in data storage device 130.

In some embodiments a security code or pin number system may be used instead of, or in conjunction with, biometric input device 910 to provide security. The security code or pin number may be stored just as the biometric data is stored, and thereafter used to verify who the user is, before allowing the apparatuses of the invention to operate as discussed above. Regardless of which security systems are implemented in the various embodiments of the invention, non-visual output device 150 and/or another component of the invention may be configured to output an unauthorized use message based at least in part on the biometric data or security code received from the user. This unauthorized use message may be configured to be received by numerous devices, and possibly by different entities. For example, the message may be configured to be received by a point-of-sale device at a merchant, service provider, and/or financial institution. The message may also be configured to be received by a mobile phone network and thereafter received by a financial institution and/or law enforcement authorities. In some embodiments, the apparatus may have a GPS receiver and be configured to transmit information determined or received by the GPS receiver with the unauthorized use message, thereby informing a recipient of the message of the location of the apparatus.

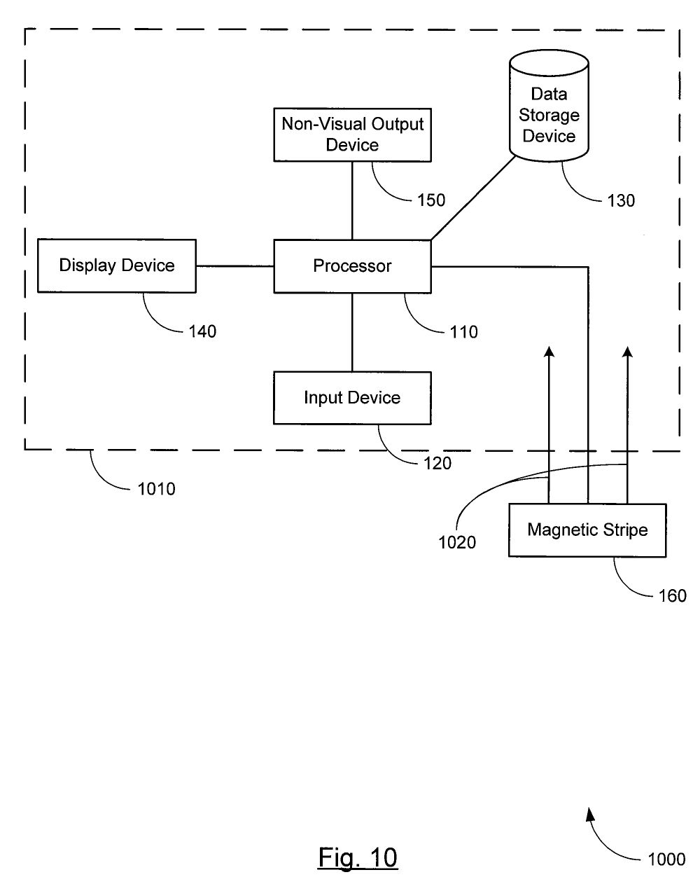

FIG. 10 is a block diagram of an embodiment 1000 of the invention similar to that shown in FIG. 1, except also including a body 1010 and showing the magnetic stripe as retractable into body 1010 (as shown by directional arrows 1020). In this embodiment, the various components of the apparatus may be contained within body 1010 to protect them from the elements, misuse, or accidents. In some embodiments, body 1010 may be made from plastic, polymers, metal, composites, and/or other materials suitable to resisting damage likely to be incurred during day-to-day carrying by a user. The outer edges of the body may allow various components to be in communication with other devices. For example, serial and parallel connections 120I, 150C may be located at an outer edge of body 1010, thereby allowing access via a cable or other connector to the component. Display devices 140 having a screen may have the screen located at a void defined in body 1010 that is co-extensive in size and shape with the screen size. In other embodiments, at least some portion of the body may be translucent so as to allow a user to observe display device 140.

Body 1010 may also have markings such as trademarks or instructions on how to use the apparatus. Additionally, body 1010 may have marking indicators to notify a user of the location of other components within the device. For example, markings to indicate the location of RDIF transponder 120G, 150A within the device, so that a user may co-locate RDIF transponder 120G, 150A with a location on another device that is configured to communicate with the apparatus.

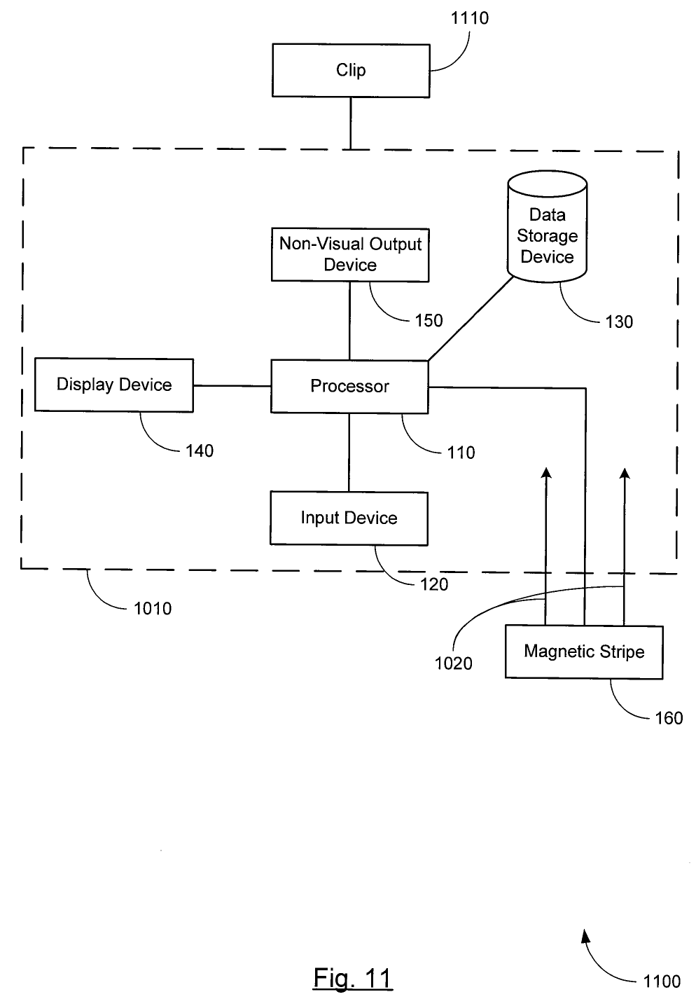

FIG. 11 is a block diagram of an embodiment 1100 of the invention similar to that shown in FIG. 10, except also including a clip 1110. The clip may be configured to attach the apparatus to the clothing of a user, possibly a belt for example. In other embodiments, the clip may be used to compress items between clip 1110 and body 1010. This may allow the apparatus to be used as a money clip, with paper money and/or other items stored between the clip and the body.

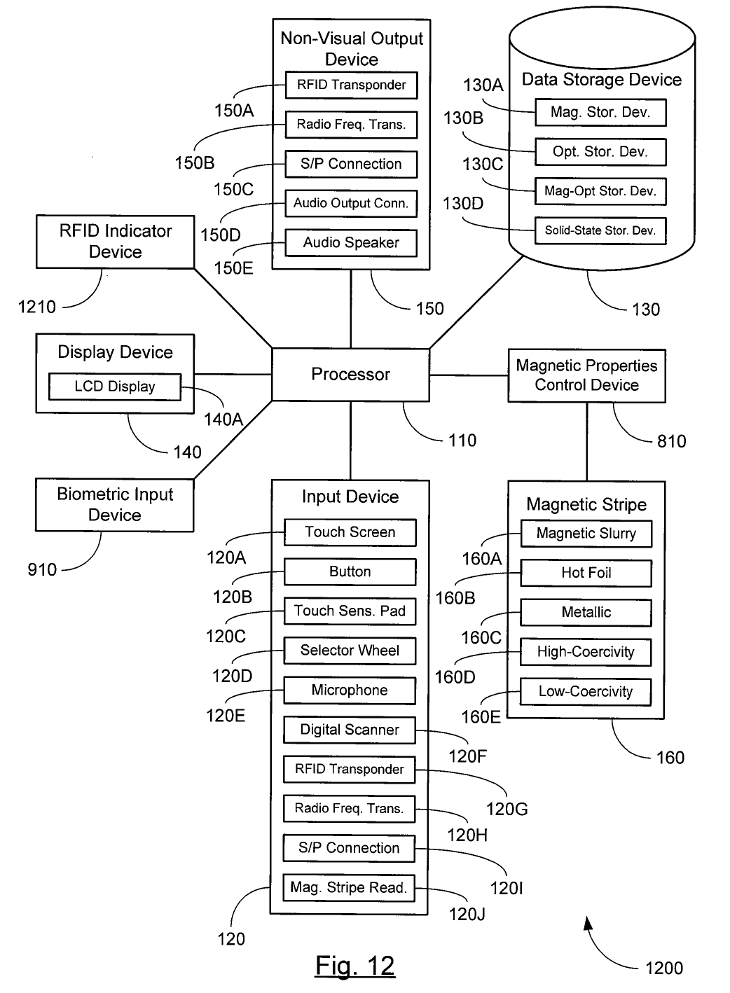

FIG. 12 is a block diagram of an embodiment 1200 of the invention similar to that shown in FIG. 9, except also including a RFID indicator device 1210. RFID indicator device 1210 may be configured to inform a user that an RFID transceiver is within range, possibly in a point-of-sale device. This may inform a user of the apparatus that a point-of-sale device with an RFID transceiver is either available for conducting a transaction, or is waiting for the user to initiate further activity by moving the apparatus closer to the point-of-sale device or directing the apparatus to allow the RFID transponder to transmit.

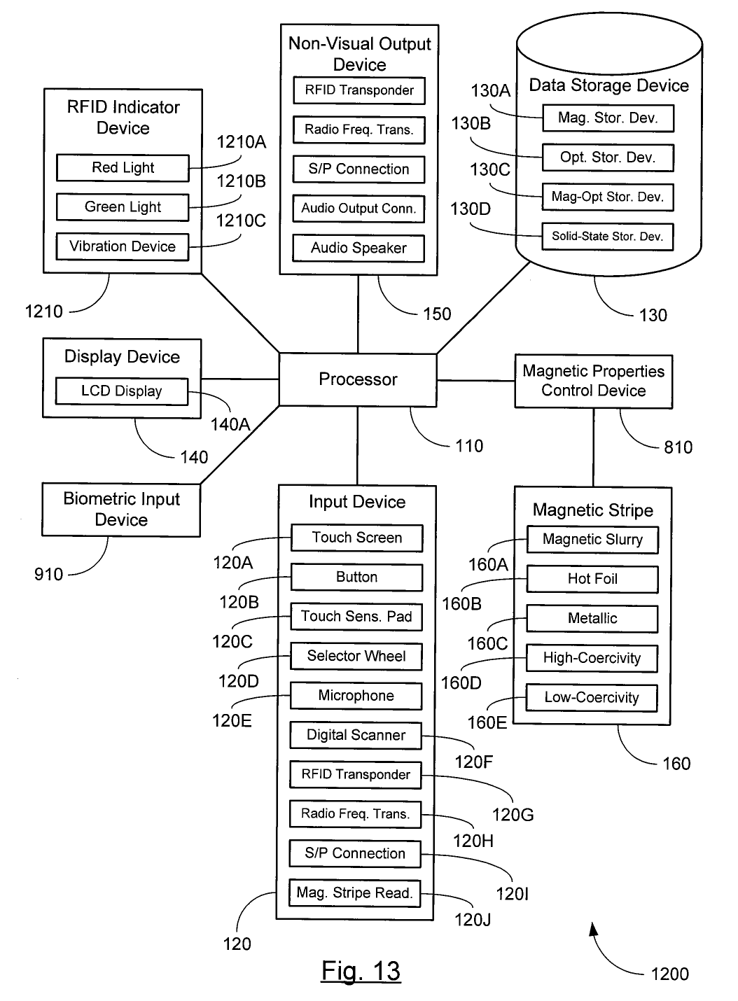

FIG. 13 is a block diagram of an embodiment of the invention similar to that shown in FIG. 12, except showing RFID indicator device 1210 including a red light 1210A, a green light 1210B and a vibration device 1210C. In this embodiment, red light 1210A may be configured to illuminate when a radio frequency transceiver is not available for communication. Red light 1210A may be constantly illuminated in a normal state, or may illuminate when a user is attempting to initiate an RFID transaction, but a transceiver is not available. Green light 1210B may illuminate when a radio frequency transceiver is available for communication. Green light 1210B may illuminate whenever an RFID transceiver is available for communication, or it may illuminate when an RFID transceiver is available for communication and the user is attempting to initiate an RFID transaction. Vibration device 1210C may be configured to vibrate for a certain time, and thereby notify a user through the user's senses, when an RFID transceiver first becomes available for communication.

In some embodiments, RFID indicator device 1210 may indicate to a user of the apparatus that a transaction has succeeded and has been completed with the merchant, service provider, or financial institution. RFID indicator device 1210 may do this in various ways, including, but not limited to, blinking green light 1210B or intermittently activating vibration device 1210C. In some embodiments, if the transaction is not successful, RFID indicator device 1210 may indicate such a failure to the user, for example, by blinking red light 1210A or prolonged, intermittent activation of vibration device 1210C.

In some embodiments, the certain time which vibration device 1210C vibrates may be configurable by a user, possibly by using input device 120. Though in this embodiment RFID indicator device 1210 consists of red light 1210A, green light 1210B and vibration device 1210C, other configurations are also possible. Additionally, other components of the apparatus, for example display device 140 and/or non-visual output device 150 may instead, or additionally, indicate to a user that an RFID transceiver is available. Also, RFID indicator device 1210 may also be configured to indicate if other communication methods are available to and/or successful for performing transactions, including, for example, wireless networking.

In some embodiments the apparatus may also include a blue light to indicate Bluetooth communication activity independent of RFID activity. In some embodiments, the blue light may blink when a Bluetooth communication source is available, and may glow steadily when a communication link has been established. In other embodiments, different color lights and/or indication schemes may also be employed. In some embodiments, RFID indicator device 1210 may consists of a single multi-color light point. The single multi-color light point may use the same green, red and blue lights described above, in the same manner, or may use other lights and/or indication schemes.

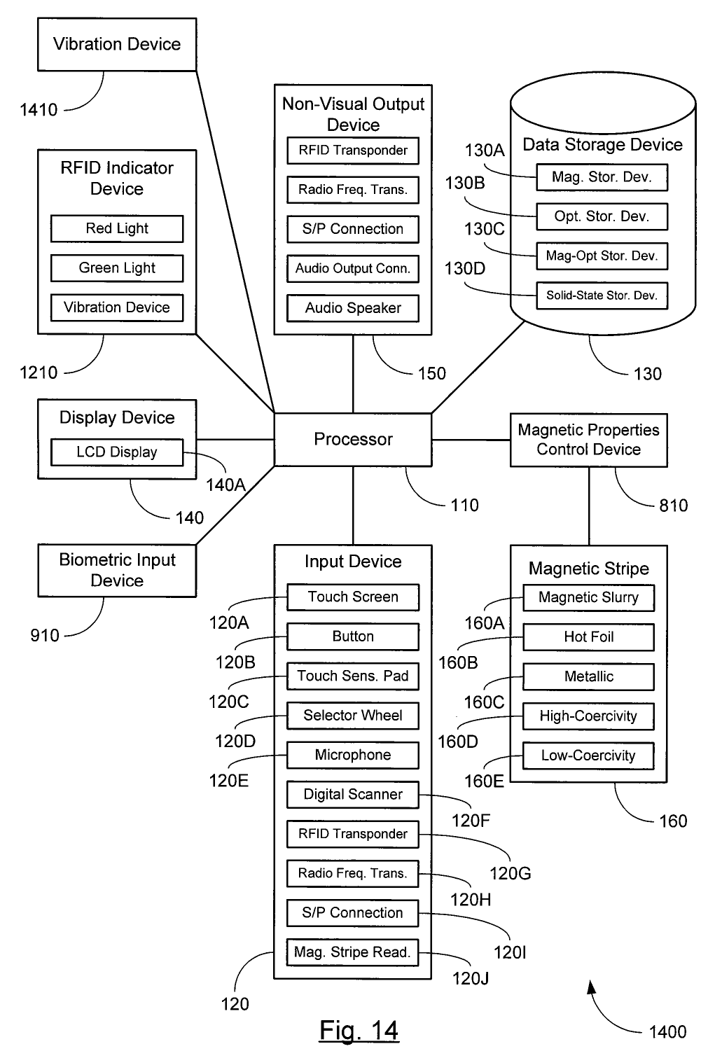

FIG. 14 is a block diagram of an embodiment 1400 of the invention similar to that shown in FIG. 13, except also including a vibration device 1410. Vibration device 1410 may be configured to vibrate for a certain time when at least one of processor 110, input device 120, data storage device 130, display device 140, and non-visual output-device is active. This may notify a user, through the user's senses, when the apparatus is requesting user input or wishes to inform the user of activity. Other components of the apparatus may also activate to notify the user in conjunction with vibration device 1410, including, for example, display device 140, and non-visual output-device 150. In some embodiments, vibration device 1410 may be integral with, or the same as, vibration device 1210C.

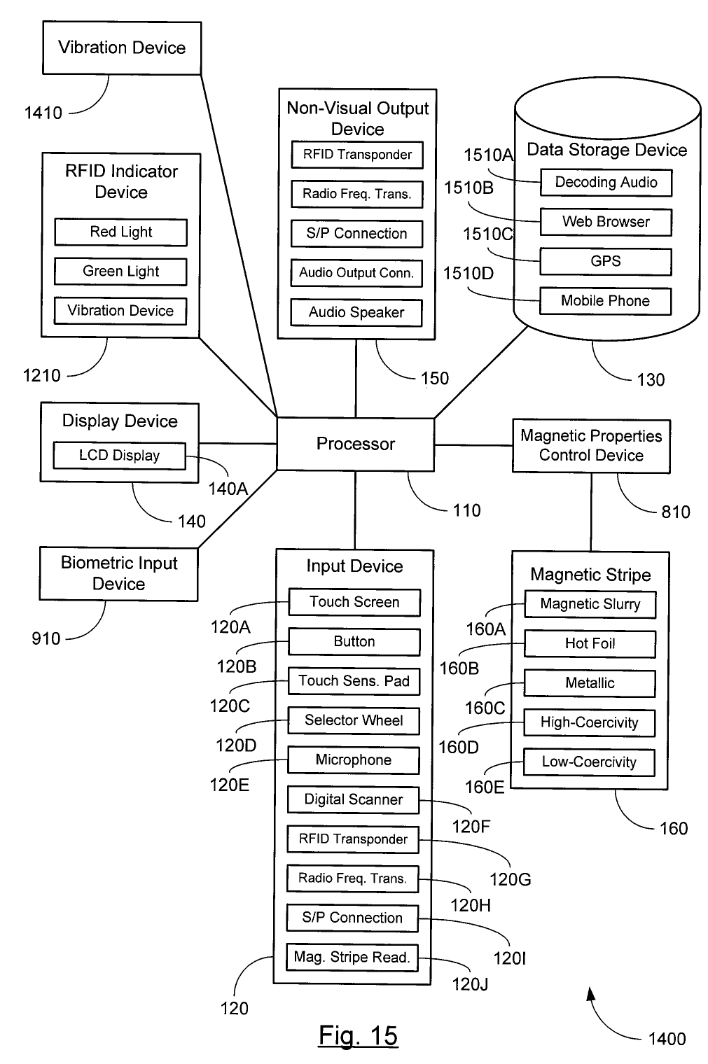

FIG. 15 is a block diagram of an embodiment 1400 of the invention similar to that shown in FIG. 14, except also showing various instructions executable by processor 110, and stored on data storage device 130. Data storage device 130 may have instructions stored for decoding audio files 1510A, for providing a web browser in communication with the Internet 1510B, for processing a received global positioning system (“GPS”) transmission 1510C, and/or for processing a mobile phone transmission 1510D. Other possible instructions held on data storage device may include instructions for decoding video files, decoding satellite music radio signals, or for providing altitude and/or other environmental indicators such as air temperature or barometric pressure. The apparatus may also have other hardware and/or components necessary or advantageous to implement such instructions. For instance, a GPS receiver or a mobile phone receiver may also be included in some embodiments of the invention to assist in implementing the above mentioned instructions. In some embodiments, these additional components may contain the processor by which these instructions are executed rather than the main processor 110 of the apparatus. In other embodiments, radio frequency transceiver 120H may be used to receive GPS, mobile phone, wireless networking and other data necessary for such instructions to be executed.

In embodiments which have instructions stored on data storage device 130 executable by processor 110 to decode audio files 1510A, or other hardware and/or components that may decode audio files, various formats may be supported. Merely by way of example, MP3, M4P, and WMV are audio formats which may be supported. Various components of the apparatus may also be configured to integrate and interact with Apple iPod™ music and video devices, Apple iTunes™ software, and Apple online music store. Other online media services such as MSN Music™, Napster™, and Yahoo Music™, and media devices such as Creative Labs Zen™ and Samsung yepp′™ may also be supported. Merely by way of example, components of the apparatus may be configured to interact with these services and devices through input device 120 and non-visual output device 150, possibly via a personal computer, or possibly directly. The apparatus may therefore be configured to act as one of the aforementioned devices, or at least some portion of the aforementioned devices.

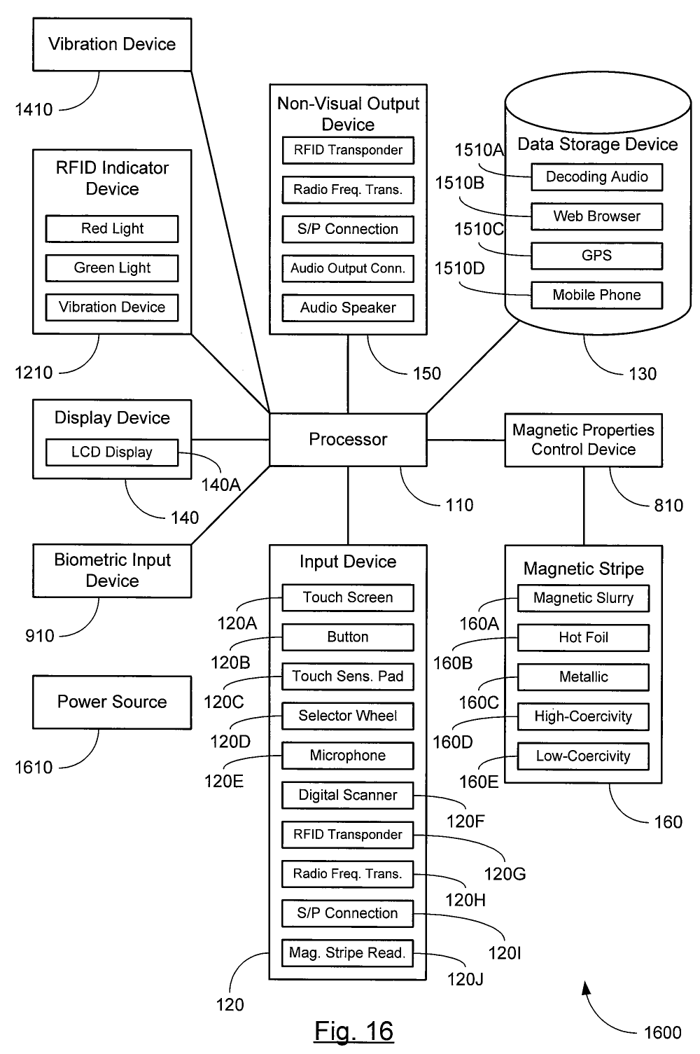

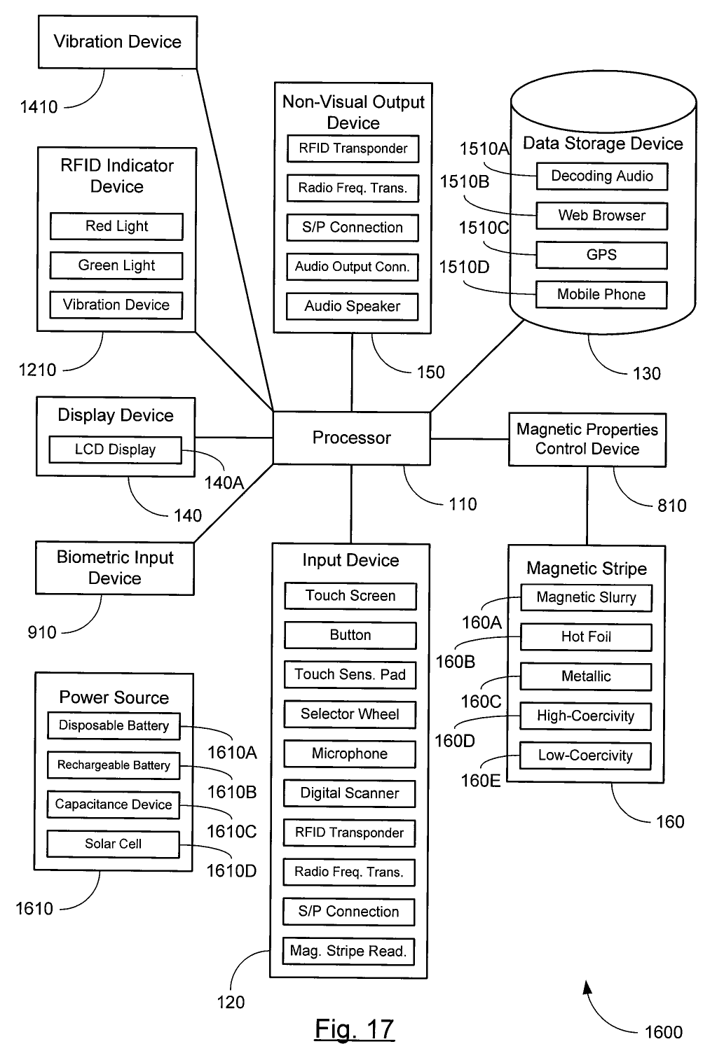

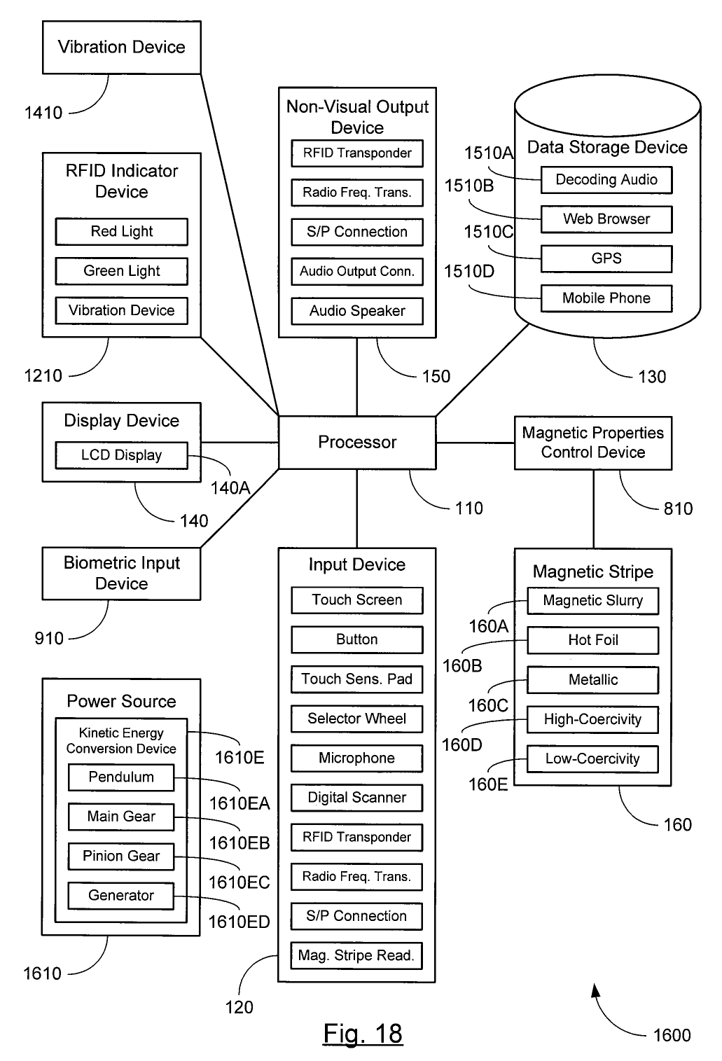

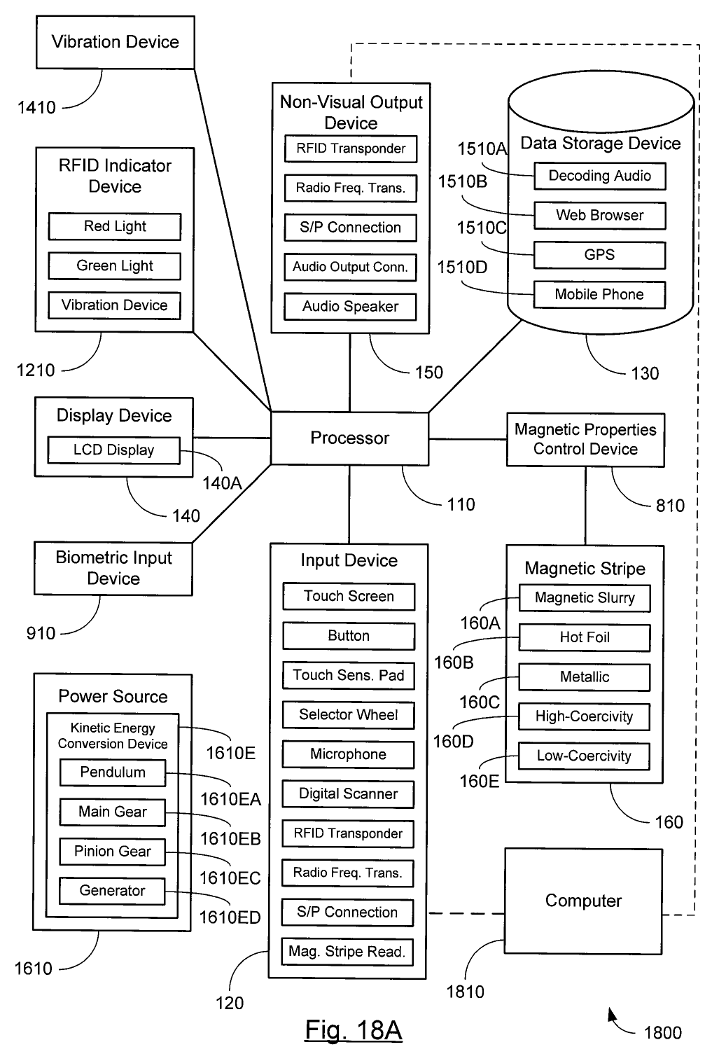

FIG. 16 is a block diagram of an embodiment 1600 of the invention similar to that shown in FIG. 15, except also including a power source 1610. FIG. 17 is a block diagram of an embodiment 1600 of the invention similar to that shown in FIG. 16, except showing different types of possible power sources 1610. In some embodiments, power source 1610 may be a disposable battery 1610A, a rechargeable battery 1610B, a capacitance device 1610C, and/or a solar cell 1610D. FIG. 18 is a block diagram of an embodiment of the invention similar to that shown in FIG. 16, except showing power source 1610 including a kinetic energy conversion device 1610E. Kinetic energy conversion device 1610E may include a pendulum 1610EA, a main gear 1610EB, a pinion gear 1610EC, and a generator 1610ED. Pendulum 1610EA may be fixedly coupled with main gear 1610EB, and pinion gear 1610EC may be meshed with main gear 1610EB. Generator 1610ED may be operably coupled with pinion gear 1610EC. Motion of kinetic energy conversion device 1610E may cause pendulum 1610EA to rotate, thereby rotating main gear 1610EB, thereby rotating pinion gear 1610EC, thereby operating a rotatable portion of generator 1610ED, and thereby creating electrical power. This power may, in some embodiments, be stored in rechargeable battery 1610B or capacitance device 1610C.

FIG. 18A is a block diagram of an embodiment 1800 of the invention similar to that shown in FIG. 18, except showing a computer 1810 in communication with input device 120 and non-visual output device 150. In some embodiments, computer 1810, possibly a personal computer such as a laptop, notebook, or desktop, may be configured, possibly with software, to communicated with the apparatus via input device 120 and/or non-visual-output device 120. In some embodiments, a user of the apparatus may access a website or other interface using computer to apply for credit cards, debit cards, or other personal financial instruments. If approved for a specific financial instrument, the computer may download information necessary to provide the apparatus with information necessary to conduct transactions using the financial instrument. Such information may be encrypted when transferred over the Internet or other medium, and may be stored on data storage device 130 after being transferred to the device from computer 1810. In these or other embodiments, other types of data sources may also be applied for online and transferred to the apparatus. For instance, memberships in various organizations, and/or drivers licenses. In some embodiments, graphics or other type of multimedia information may be downloaded to the apparatus to assist in creating icons for various payment sources. For instance, if a Home Depot™ store credit card is applied for and granted online, then a graphic may be download of a Home Depot™ trademark or other commercially recognizable symbol. The trademark or symbol may then be used as an icon in certain menus on the display device 140 to provide a method for a user to quickly distinguish between different data sources stored in the apparatus.

In some embodiments, computer 1810 may be provided with software that manages all of the data stored on data storage device 130. When the apparatus comes into communication with computer, possibly with input device 120 or non-visual output device 150, the software on computer 1810 may synchronize the data in data storage device 130 with a set of data on computer 1810. In this way, if new data is added via the apparatus to data storage device 130, the new data may be stored on computer 1810 the next time they come into communication with each other and synchronize. Likewise, if new data is added to the computer, the new data may be stored on data storage device 130 the next time they come into communication with each other and synchronize. In this way a backup may be maintained of the data on computer 1810. The software also may allow for general maintenance and management of the data sources. The software which provides access to the data on computer 1810 as well as synchronizing, maintenance, and/or managing functionality may be protected via a password, pin code, and/or biometric method, just as has been discussed above in regard to the apparatus itself.

In some embodiments the software may allow for multiple profiles in which data sources for different individuals may be stored and/or accessed by the software. In these embodiments, multiple users may use the same software to store, backup, synchronize, maintain, and/or manage their respective data sources. Access to any one profile may be restricted by password, pin code, and/or biometric method as discussed above.

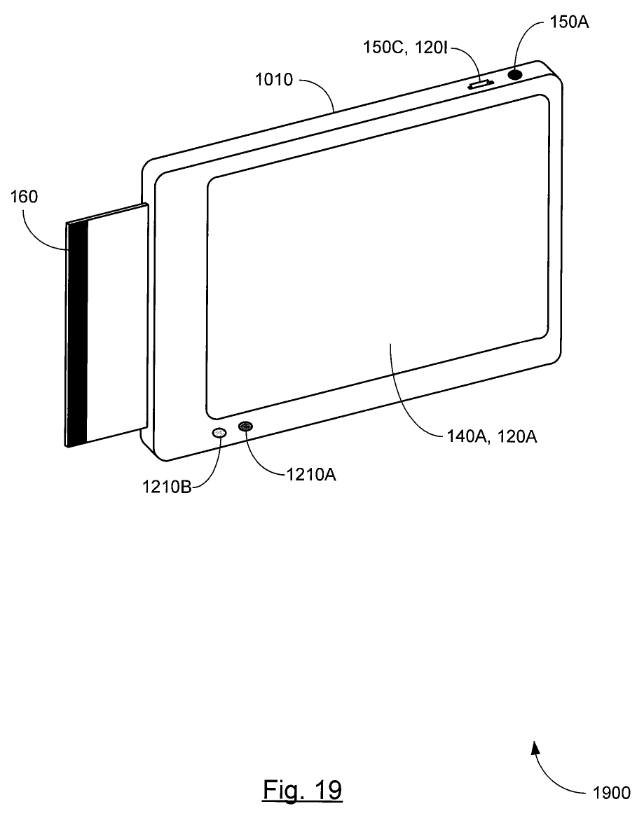

FIG. 19 is an isometric drawing of one apparatus 1900 of the invention for storing and outputting data from a plurality of data sources. Apparatus 1900 is shown having body 1010 and LCD screen 140A, which may also, in this embodiment, be touch screen 120A. Retractable magnetic stripe 160 in its un-retracted state is also shown. Red light 1210A and green light 1210B of RFID indicator device 1210 are shown. A serial or parallel connection 1201, 150C is also shown (in this embodiment it is shown as a USB Mini-B type connection). Finally, RFID transponder 150A is also shown.

In use, a user may input, using touch screen 120A, data from a plurality of data sources such as credit and debit cards. The apparatus 1900 may store the data received, possibly on a data storage device 130, not seen in this figure, but internal to body 1010. Later, when the user is at a merchant, provider of services, or financial institution, the user may select a portion of data representative of a particular data source to provide payment at the location. Apparatus 1900 may store the data to magnetic stripe 160, possibly by using magnetic stripe encoder 710 or magnetic properties control device 810, not seen in this figure, but internal to body 1010. The user or a clerk may then swipe magnetic stripe through a point-of-sale device with a magnetic stripe reader to transfer the data to the point-of-sale device and commence processing of the transaction.

In other instances, green light 1210B of RFID indicator device 1210 may indicate to the user that an RDIF transceiver is within range and ready to accept an RFID transmission of the payment data. In these instances, instead of using magnetic stripe 160, the user may bring RFID transponder 150A in proximity to a portion of the point-of-sale device. A RFID transceiver in the point-of-sale device may send a signal to RFID transponder 150A, thereby causing RFID transponder 150A to transmit the selected data for processing by the point-of-sale device. In yet other instances, other data such as membership information, identification information, and/or security information may be stored, selected, and output by apparatus 1900 or other apparatuses of the invention.

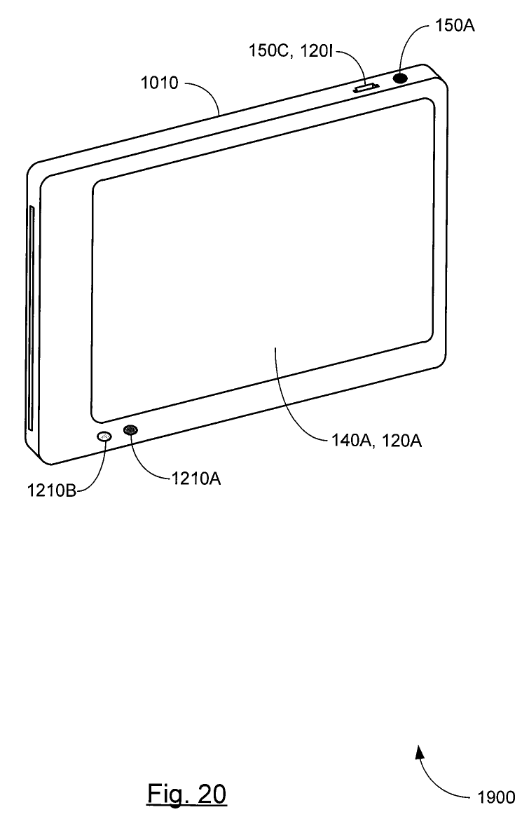

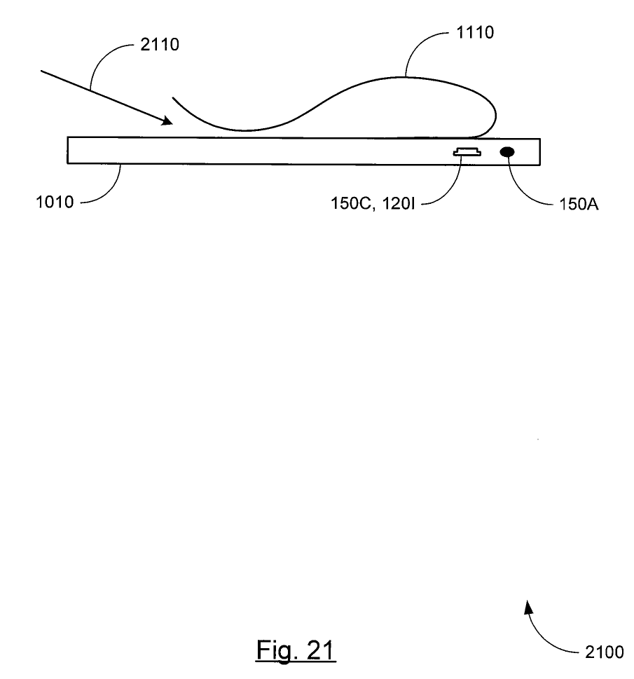

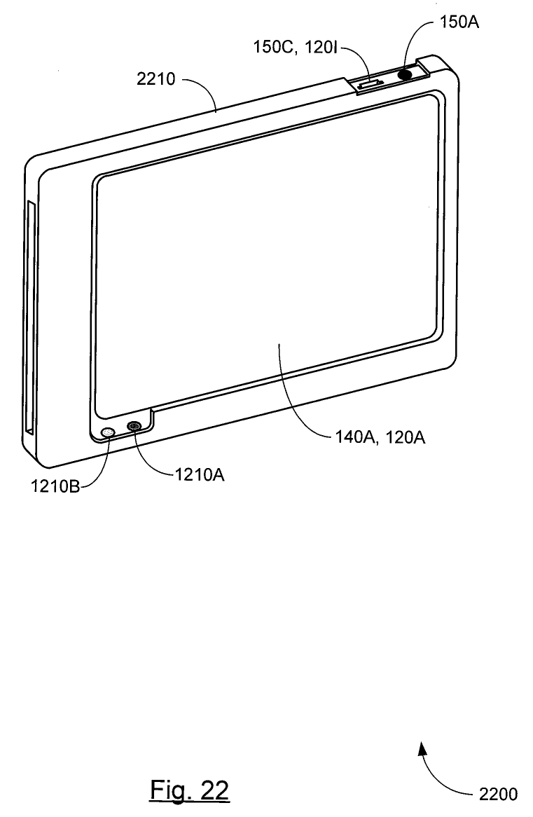

FIG. 20 is an isometric drawing of an embodiment 1900 of the invention similar to that shown in FIG. 19, except showing magnetic stripe 160 in the retracted position. FIG. 21 is a side view of an embodiment 2100 of the invention similar to that shown in FIG. 19, except showing clip 1110. Money and/or other object may be inserted in between clip 1110 and body 1010 as shown by directional arrow 2110 to compress them between clip 1110 and body 1010. Clip 1110 may also be used to temporarily attach apparatus 2100 to clothing such as a belt. FIG. 22 is an isometric drawing of an embodiment 2200 of the invention similar to that shown in FIG. 19, except also including a cover 2210. Cover 2210 may be made of polymer, plastic, leather, composite, or other material suitable to protect the apparatus 2200, and components thereof, from damage or misuse. Cover 2210 may include openings to allow various components, for example, display device 140, magnetic stripe 160 or RFID indicator device 1210 components to protrude, be seen, or be accessed by a user.

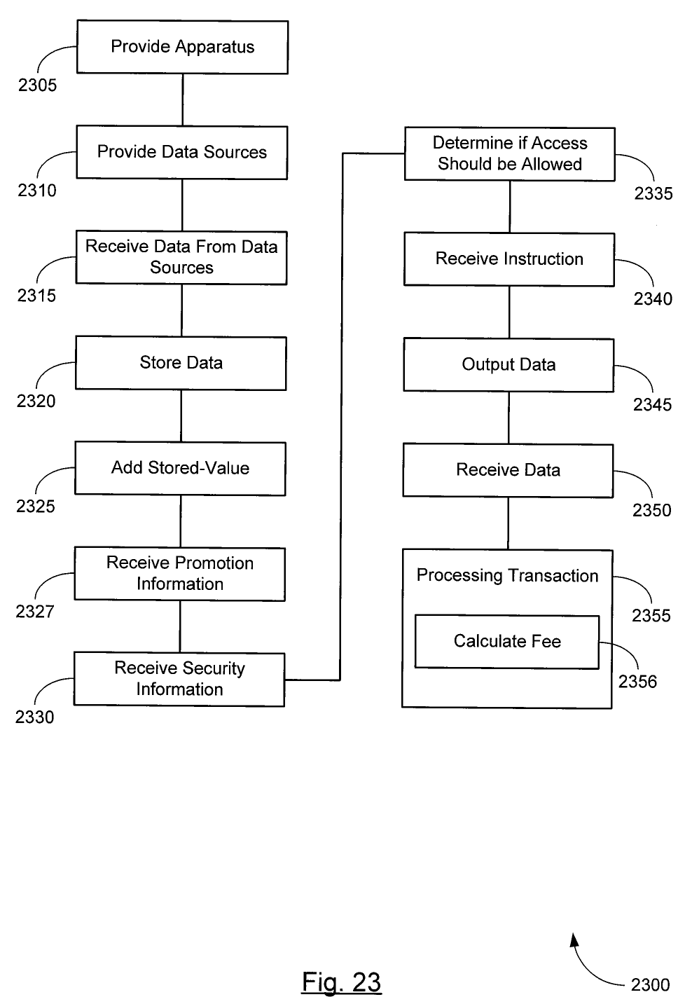

FIG. 23 is a block diagram of one method 2300 of the invention for storing and outputting data from a plurality of data sources. At block 2305, an apparatus may be provided. At block 2310, a plurality of data sources may be provided. At block 2315, data may be received by the apparatus from the data sources. At block 2320, the data may be stored. At block 2325, a user may direct stored-value to be added to an account represented by data stored on the device. At block 2327, the apparatus may receive promotion information, possibly due to the apparatus establishing communications with a merchant, service provider, or financial institution associated with the promotion information. The apparatus may inform the user of such promotion information, for example, through the display device. At block 2330, the apparatus may receive security information from a user. At block 2335, the apparatus may determine if access should be allowed. At block 2340, the apparatus may receive instruction on which data to output. At block 2345, the data may be outputted (possibly by being stored on a magnetic stripe. At block 2350, the apparatus may receive return, possibly receipt, data, related to the outputted data. At block 2355, a point-of-sale device, which may have received the outputted data, may process the transaction for which the data was provided. At block 2356, as part of processing the transaction, the point-of-sale device, or other device in communication with the point-of-sale device, may also calculate a fee associated with the transaction, possibly because the apparatus was used to commence the transaction.

A number of variations, additions, and/or modifications of the disclosed embodiments can also be used within the scope of the invention. For example, some embodiments of the invention may monitor account balances and their relation to credit limits of accounts represented by data stored in an apparatus of the invention. These embodiments may inform the user using display device 140 and/or non-visual display device 150, that a user is nearing a credit limit input by the user, or communicated to the apparatus by a financial institution. The balance may be retained by an apparatus of the invention, periodically checked and/or updated with an account balance stored by the creditor, or only downloaded from the creditor.

In some embodiments, processor 110 and/or other components of the invention may be configured to monitor a consumer loyalty program associated with at least one of the data sources for which data is stored. Processor 110 (and/or other components), may deliver consumer loyalty data to point-of-sale devices or store clerks when directed to do so by a user of the apparatuses of the invention. In other embodiments, the apparatus may determine that a sale with a particular merchant is occurring and transmit loyalty program information with payment data (possibly by storing such information with other data on magnetic stripe 160). A user of the apparatus may, in some embodiments, later access information stored on the apparatus to determine what rewards or other incentives are available to the user as a result of past purchases.

Various apparatus embodiments of the invention may also be configured to interact with other systems for the convenience of a user. In one embodiment, the data storage device 130, and/or other component of the apparatus may comprise instructions executable by the processor and/or other component of the apparatus. These instructions may be executable for determining if a computer in communication with input device 120 has communicated with a merchant's, a service provider's, or a financial institution's web-site, and for taking at least one specific action in response to such a determination. One possible specific action may include selecting data stored in data storage device 130 based at least in part on which merchant, service provider or financial institution web-site the computer is in communication with; and outputting, through non-visual output device 150, the selected data for reception by the computer. In one example, if a user accesses a certain retail store's web-site, the apparatus may select and output data received from a retail store credit card associated with the certain retail store. The computer may receive this data and use it to process any transactions initiated by the user with the web-site.

In another embodiment, a component of the apparatus may contain instructions executable for determining that a user using input device 120 has selected data received from a certain data source associated with a merchant, a service provider, or a financial institution; and outputting through non-visual output device 150, instructions to a computer for taking at least one specific action in response to such determination. The one specific action may, in some embodiments, be communicating with the associated merchant's, service provider's, or financial institution's web-site; and receiving, from non-visual output device 150, the selected data for use in transactions. In some embodiments, the apparatus may only execute such instructions if the computer is already in communication with the apparatus, while in other embodiments, the apparatus may establish communications with a computer to execute the instructions.

In some embodiments, display device 140 may be configured to display a promotion in response to input device 120 establishing communication with a merchant, a service provider, or a financial institution. The promotion may, merely by way of example, be a coupon, sale information, and/or financing information. Input device 120, in some embodiments, may be configured to establish communication with a wireless network, or other radio frequency network, whenever one is available. In some instances, these networks may be established by a merchant, a service provider, or a financial institution for the purpose of communicating promotions to potential customers who come within range of these networks. When communication with a merchant, a service provider, or a financial institution is established, the apparatus may request, or may automatically receive promotions. In some embodiments, display device 140 may then display these promotions. A user may, in some embodiments, decide to disable any portion of the described embodiment, or at least automatic operation of the described embodiment. For example, in some embodiments, a user may be able to instruct the apparatus to seek promotions rather than to accept them automatically.

In yet another embodiment, display device 140 may be configured to display a representation of at least one desired good or service associated with a merchant, a service provider, or a financial institution in response to input device 120 establishing communication with the merchant, service provider, or financial institution. The representation may, in some embodiments, be a grocery list or other list of items or services a user needs from the merchant, service provider, or financial institution. A user may input the desired good or service into the apparatus, possibly using input device 120, or an associated system such as a computer which thereafter transfers the information to the apparatus. When the user is later carrying the apparatus, the apparatus may establish communication with the merchant, service provider, or financial institution for which associated good and/or services are required. As discussed above, this may occur when the apparatus enters into a radio frequency network associated with the merchant, service provider, or financial institution.

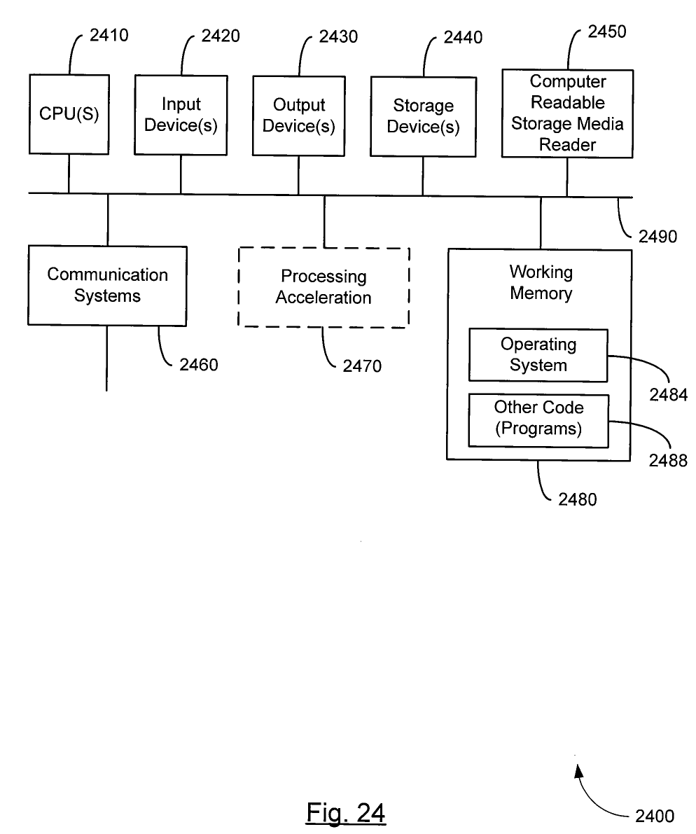

FIG. 24 is a block diagram illustrating an exemplary computer system 2400 in which at least portions of embodiments of the present invention may be implemented. This example illustrates a computer system 2400 such as may be used, in whole, in part, or with various modifications, to provide the functions of processor 110, input device 120, data storage device 130, display device 140, non-visual output device 150, magnetic stripe encoder 710, magnetic properties control device 810, biometric input device 910, RFID Indicator device 1210, vibration device 1410, and/or other components of the invention such as those discussed above. For example, various functions of the apparatus may be controlled and/or executed by the computer system 2400, including, merely by way of example, instructions for decoding audio data files 1510A, instructions for providing a web browser in communication with the Internet 1510B, instructions for processing a received global positioning system transmission 1510C, instructions for processing a mobile phone transmission 1510D, etc.

The computer system 2400 is shown comprising hardware elements that may be electrically coupled via a bus 2490. The hardware elements may include one or more central processing units 2410, one or more input devices 2420 (e.g., a mouse, a keyboard, etc.), and one or more output devices 2430 (e.g., a display device, a printer, etc.). The computer system 2400 may also include one or more storage device 2440. By way of example, storage device(s) 2440 may be disk drives, optical storage devices, solid-state storage device such as a random access memory (“RAM”) and/or a read-only memory (“ROM”), which can be programmable, flash-updateable and/or the like.

The computer system 2400 may additionally include a computer-readable storage media reader 2450, a communications system 2460 (e.g., a modem, a network card (wireless or wired), an infra-red communication device, Bluetooth device, cellular communication device, etc.), and working memory 2480, which may include RAM and ROM devices as described above. In some embodiments, the computer system 2400 may also include a processing acceleration unit 2470, which can include a digital signal processor, a special-purpose processor and/or the like.

The computer-readable storage media reader 2450 can further be connected to a computer-readable storage medium, together (and, optionally, in combination with storage device(s) 2440) comprehensively representing remote, local, fixed, and/or removable storage devices plus storage media for temporarily and/or more permanently containing computer-readable information. The communications system 2460 may permit data to be exchanged with a network, system, computer and/or other component described above.

The computer system 2400 may also comprise software elements, shown as being currently located within a working memory 2480, including an operating system 2484 and/or other code 2488. It should be appreciated that alternate embodiments of a computer system 2400 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 2400 may include code 2488 for implementing any or all of the function of the various elements of the architecture as described herein. For example, software, stored on and/or executed by a computer system such as system 2400, can provide the functions of processor 110, input device 120, data storage device 130, display device 140, non-visual output device 150, magnetic stripe encoder 710, magnetic properties control device 810, biometric input device 910, RFID Indicator device 1210, vibration device 1410, and/or other components of the invention such as those discussed above. Methods implementable by software on some of these components have been discussed above in more detail.

The invention has bow been described in detail for the purposes of clarity and understanding. However, it will be appreciated that certain changes and modifications may be practiced within the scope of the appended claims.

What is claimed is:

1. A mobile payment device comprising:
a body;
an input device configured to receive data from a plurality of data sources; and
a substrate having a magnetic stripe, wherein:
the magnetic stripe is configured to store data received from at least one of the plurality of data sources;
the substrate is movably coupled with the body and is configured to move between a first and a second position;
the magnetic stripe at least partially protrudes from the body in the first position; and
the magnetic stripe does not protrude from the body in the second position.

2. The mobile payment device of claim 1, wherein the magnetic stripe is characterized by magnetic properties and the apparatus further comprises a magnetic stripe encoder configured to change the magnetic properties of the magnetic stripe.

3. The mobile payment device of claim 1, wherein the mobile payment device further comprises a display device, wherein the display device is configured to display a graphical interface, and wherein the input device is further configured to allow a user to interact with the graphical interface.

4. The mobile payment device of claim 3, wherein the graphical interface is hierarchical, wherein a primary hierarchical level is categories of data sources; and where a secondary hierarchical level is at least one of the plurality of data sources.

5. The mobile payment device of claim 3, wherein user interaction with the graphical interface at least partially determines which data from the plurality of data sources is stored in the magnetic stripe.

6. The mobile payment device of claim 3, wherein the display device and the input device are integrated, and wherein the integrated display device and input device comprises a touch screen.

7. The mobile payment device of claim 1, wherein the mobile payment device further comprises a processor, and wherein the processor is configured to monitor a credit limit or a balance associated with at least one of the plurality of data sources.

8. The mobile payment device of claim 1, wherein the mobile payment device further comprises a processor, and wherein the processor is configured to monitor a consumer loyalty program associated with at least one data source.

9. The mobile payment device of claim 1, wherein the input device is further configured to receive security information from a user and the substrate is configured to be at least temporarily locked in the second position based at least in part on the security information.

10. The mobile payment device of claim 9, wherein the mobile payment device further comprises a non-visual output device, and wherein the non-visual output device is configured to transmit an unauthorized use message based at least in part on the security information received from the user.

11. The mobile payment device of claim 1, wherein the apparatus further comprises a radio frequency identification indicator device and a radio frequency identification transponder, and the radio frequency identification indicator device is configured to indicate to a user that a radio frequency identification transceiver is or is not available for communication with the radio frequency identification transponder.

12. The mobile payment device of claim 1, wherein the mobile payment device further comprises a processor configured to:
determine if a computer in communication with the input device has communicated with a merchant, a service provider, or a financial institution web-site;
select data received from a certain data source based at least in part on which merchant, service provider, or financial institution web-site the computer has communicated with, wherein; and
store the data from the certain data source to a non-visual output device.

13. The mobile payment device of claim 1, wherein the mobile payment device further comprises a non-visual output device and a processor configured to:
determine that a user, using the input device, has selected data received from a certain data source associated with a merchant, a service provider, or a financial institution; and
output, through the non-visual output device, instructions to a computer for taking at least one specific action in response to a determination that the user using the input device has selected data received from a certain data source associated with the merchant, the service provider, or the financial institution.

14. The mobile payment device of claim 13, wherein the at least one specific action comprises:
communicating with the associated merchant's, service provider's, or financial institution's web-site; and
receiving, from the non-visual output device, the selected data.

15. The mobile payment device of claim 1, wherein the mobile payment device further comprises a processor and a display device configured to display a promotion in response to the processor establishing communication with a merchant, a service provider, or a financial institution.

16. A method for storing and outputting data from a plurality of data sources comprising:
providing a mobile payment device with a retractable magnetic stripe;
receiving, at the mobile payment device, data from a plurality of data sources;
selecting, at the mobile payment device, one of the plurality of data sources; and
storing data from at least one of the plurality of data sources on the retractable magnetic stripe.

17. The method for storing and outputting data from a plurality of data sources of claim 16, wherein the method further comprises providing a graphical interface, at the mobile payment device, and wherein selecting, at the mobile payment device, one of the plurality of data sources comprises user interaction with the graphical interface.

18. The method for storing and outputting data from a plurality of data sources of claim 16, wherein the method further comprises monitoring a credit limit or a balance associated with at least one of the plurality of data sources.

19. The method for storing and outputting data from a plurality of data sources of claim 16, wherein the method further comprises monitoring a consumer loyalty program associated with at least one of the plurality of data sources.

20. The method for storing and outputting data from a plurality of data sources of claim 16, wherein the method further comprises:
receiving, at the mobile payment device, security information from a user; and
locking the magnetic stripe in a retracted position based at least in part on the security information.

21. The method for storing and outputting data from a plurality of data sources of claim 16, wherein the method further comprises:
receiving, at the mobile payment device, security information from a user; and
transmitting an unauthorized use message to a system remote from the mobile payment device based at least in part on the security information.

22. The method for storing and outputting data from a plurality of data sources of claim 16, wherein the method further comprises determining, at the mobile payment device, that a radio frequency identification transceiver is or is not available for communication with a radio frequency identification transponder local at the mobile payment device.

23. The method for storing and outputting data from a plurality of data sources of claim 16, wherein the method further comprises:
determining if a computer in communication with the mobile payment device has communicated with a merchant, a service provider, or a financial institution web-site;
selecting data received from a certain data source based at least in part on which merchant, service provider, or financial institution web-site the computer has communicated with, wherein; and
outputting, at the mobile payment device, the data from the certain data source via a non-visual output device.

24. The method for storing and outputting data from a plurality of data sources of claim 16, wherein the method further comprises:
determining that a user has selected data received from a certain data source associated with a merchant, a service provider, or a financial institution; and
outputting, through the non-visual output device, instructions to a computer for taking at least one specific action in response to a determination that the user using the input device has selected data received from a certain data source associated with the merchant, the service provider, or the financial institution.

25. The method for storing and outputting data from a plurality of data sources of claim 16, wherein the method further comprises:
displaying, at the mobile payment device, a promotion in response to the mobile payment device establishing communication with a merchant, a service provider, or a financial institution.
